(19) United States
(12) Patent Application Publication
(10) Pub. No.: US 2016/0013604 A1
(43) Pub. Date: Jan. 14, 2016

(54) Systems and Methods for Protecting a Cut End of an Electrical Conductor

(71) Applicant: Super Seal Corporation, Stratford, CT (US)

(72) Inventor: William E. Newbauer, III, Fairfield, CT (US)

(73) Assignee: SUPER SEAL CORPORATION, Stratford, CT (US)

(21) Appl. No.: 14/796,435

(22) Filed: Jul. 10, 2015

Related U.S. Application Data
(60) Provisional application No. 62/023,720, filed on Jul. 11, 2014.

(51) Int. Cl. H01R 43/04; H01R 4/22

(52) U.S. Cl. CPC H01R 43/04; H01R 4/22

(57) ABSTRACT

Systems and methods for protecting a cut end of an electrical conductor via the use of an end cap and an end cap attachment apparatus. The end cap attachment apparatus easily and quickly heat shrinks the end cap onto the electrical conductor, thereby sealing the end. The system comprises a heat-shrinkable end cap and an end cap installation apparatus. The end cap is placed over the cut end of electrical conductor. The apparatus comprises an inner heating chamber controlled through a control panel. The end cap installation apparatus applies heat evenly and rapidly to shrink and seal the end cap onto the cut end. The method comprises placing the cut end of the electrical conductor surrounded by an unshrunken end cap into the heating inner chamber for a sufficient time to shrink the end cap onto the end of the electrical conductor and then removing.

### CROSS-REFERENCE TO RELATED APPLICATIONS

This application claims the benefit of the U.S. provisional patent application entitled “Systems and Methods for Protecting a Cut End of Wire,” having Ser. No. 62/023,720, filed Jul. 11, 2014, which is hereby incorporated by reference in its entirety as if fully set forth herein.

### BACKGROUND OF THE INVENTION

Embodiments in the present disclosure generally relate to systems and methods for protecting a cut end of an electrical conductor. More specifically, the present disclosure relates to systems and methods for protecting a cut end of an electrical conductor such as a wire, cable, or the like via the use of an end cap and an end cap attachment apparatus. However, alternate embodiments of the present invention are envisioned in which the end cap installation apparatus is utilized to seal the end of objects other than electrical conductors including, without limitation, pipe, conduit, tubing, and wood.

Cut ends of electrical conductors such as wires, optical cables, cables, and the like must be protected from damage, particularly in storage facilities in which lengths of electrical conductors are cut from large spools on an as needed basis. Heat-shrinkable end caps are often applied to the cut ends and sealed with a hand-held heat gun or a propane torch. Holding the heat gun and trying to apply the heat evenly to the end caps is tedious and time-consuming. Many work environments prohibit the use of an open flame such as a propane torch for safety reasons. The heat gun and torch do not always apply heat uniformly and how much heat is being applied generally cannot be determined.

### BRIEF SUMMARY OF THE INVENTION

Briefly stated, in one aspect of the present invention a system for protecting an end of a cut electrical conductor by sealing the end is provided. The systems comprises: a heat-shrinkable end cap configured for sealing an end of a cut electrical conductor; and an end cap installation apparatus having a housing, a heating chamber, a control panel, and a temperature sensing device coupling to the heating chamber and operationally connecting to the control panel.

In another aspect of the present invention a method for protecting an end of a cut electrical conductor by sealing the end is provided. The method comprises: setting a temperature setpoint in a heating chamber in an end cap installation apparatus to an operating temperature set point; positioning an end cap in combination with an end of a cut electrical conductor into the heating chamber in a substantially centered position through a substantially circular opening located at a first end of the heating chamber, the heating chamber rapidly shrinking the end cap onto the cut electrical conductor end; and removing the combination of the end cap and the end of the cut electrical conductor from the heating chamber after the end cap shrinks and adheres to the end of the cut electrical conductor, thereby protecting the end of the cut electrical conductor.

### BRIEF DESCRIPTION OF THE SEVERAL VIEWS OF THE DRAWINGS

The foregoing summary, as well as the following detailed description of preferred example embodiments in the present disclosure, will be better understood when read in conjunction with the appended drawings. For the purpose of illustrating the disclosure, there is shown in the drawings embodiments which are presently preferred. It should be understood, however, that the embodiments are not limited to the precise arrangements and instrumentalities shown. In the drawings:

FIG. 1 is a perspective view of an end cap installation apparatus in accordance with one embodiment of the present disclosure;

FIGS. 2A-2C depict side, closed end, and open end views of an end cap for use with the embodiment depicted in FIG. 1;

FIG. 3A depicts a cut end of an electrical conductor and an end cap prior to installation of the end cap in accordance with one embodiment in the present disclosure;

FIG. 3B depicts an end cap slid onto the end of a cut end of an electrical conductor prior to installation of the end cap in accordance with one embodiment in the present disclosure;

FIG. 3C depicts an end cap sealed to a cut end of an electrical conductor after installation of the end cap in accordance with one embodiment in the present disclosure;

FIGS. 4A-4D depict right side, rear, left side, and front views of the end cap installation apparatus of FIG. 1;

FIG. 5A depicts a right side view of the end cap installation apparatus of FIG. 1 rotated ninety degrees counterclockwise;

FIG. 5B depicts an internal view of the end cap installation apparatus of FIG. 1 in the orientation shown in FIG. 5A with the left and right sides rotated clockwise and counterclockwise, respectively, approximately ninety degrees via hinge 400;

FIG. 5C depicts a front view of the end cap installation apparatus of FIG. 1 rotated counterclockwise approximately ninety degrees;

FIG. 6 is a front view of a control panel for use with the end cap installation apparatus of FIG. 1 in accordance with one embodiment in the present disclosure;

FIG. 7 depicts exemplary wiring for the control panel of FIG. 6 in accordance with one embodiment in the present disclosure;

FIG. 8 depicts a flowchart of an exemplary method of protecting a cut electrical conductor end in accordance with one embodiment in the present disclosure; and

FIG. 9 depicts a flowchart of an exemplary alternate method of protecting a cut electrical conductor end in accordance with one embodiment in the present disclosure.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a heater” may include a plurality of heaters. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

The present disclosure relates to systems and methods for protecting a cut end of an electrical conductor via the use of an end cap and an end cap installation apparatus.

Briefly stated, in one aspect of the present disclosure, a system for sealing an end of a cut electrical conductor is provided. This system includes a heat-shrinkable end cap and an end cap installation apparatus.

In another aspect of the present disclosure, a system for sealing an end of a cut electrical conductor rapidly is provided. This system includes an end cap installation apparatus with an internal heating chamber that maintains high heat for uniformly shrinking the heat-shrinkable end cap rapidly onto the cut electrical conductor end.

In a further aspect of the present disclosure, a system for sealing an end of a cut electrical conductor evenly in a controlled manner is provided. This system includes an end cap installation apparatus with a substantially cylindrical internal heating chamber controlled through at least one control panel for shrinking the heat-shrinkable end cap in a controlled and even manner when the end of the electrical conductor and the end cap is place in a substantially centered position within the cylindrical internal heating chamber.

In yet another aspect of the present disclosure, a method for protecting an end of cut electrical conductor is provided. This method includes placing an end cap over a cut end of the electrical conductor, placing the end of the electrical conductor with the cap into a heating chamber of an end cap installation apparatus for a sufficient time to shrink the end cap onto the end of the electrical conductor and then removing the end of the electrical conductor (and its associated end cap) from the chamber.

Accordingly, the present disclosure relates to systems and methods for protecting a cut end of an electrical conductor via the use of an end cap and an end cap attachment apparatus, easily and quickly heat-shrinking the end cap onto the electrical conductor and sealing the end. The system comprises a heat-shrinkable end cap and an end cap installation apparatus. The end cap is placed over the cut end of the electrical conductor. The apparatus comprises a heating chamber electrically controlled through a control panel. The end cap installation apparatus applies heat evenly and rapidly to shrink and seal the end cap onto the cut end. The method comprises heating the chamber to an operating set point, placing the cut end of the electrical conductor surrounded by an unshrunken end cap into the heating chamber for a sufficient time to shrink the end cap onto the end of the electrical conductor, and then removing the combination of the end cap and the end of the cut electrical conductor from the heating chamber.

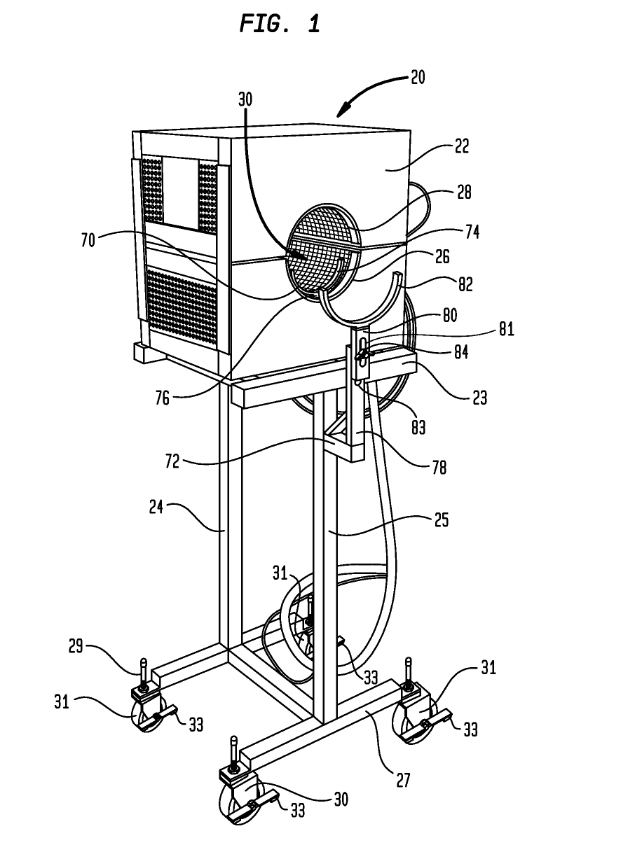

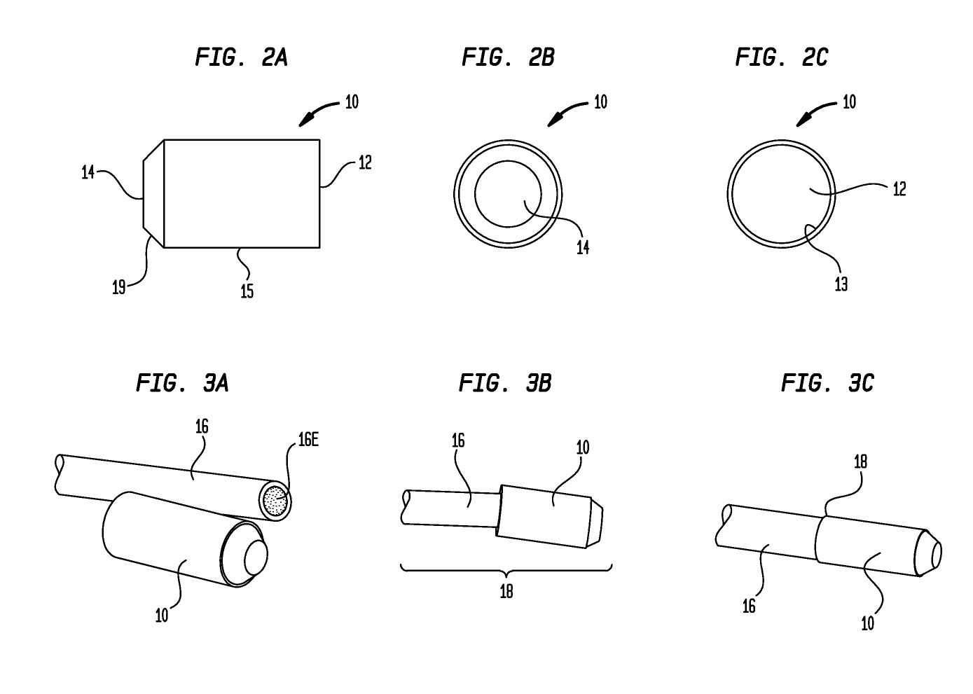

Disclosed herein is a system of protecting a cut electrical conductor end by sealing the cut electrical conductor end with an end cap and an end cap installation apparatus, the apparatus sealing the end cap onto the cut electrical conductor end. The system comprises an end cap installation apparatus 20, an example embodiment of the apparatus is shown in FIG. 1. The system further comprises in one embodiment of the present invention, an end cap 10 such as that shown in FIGS. 2A through 2C.

Shown in FIG. 1, the illustrated example embodiment of end cap installation apparatus 20 has a housing 22 on an adjustable stand 24. That is, in the depicted embodiment, stand 24 includes a support 23, legs 25, and base 27. The base 27 includes threaded pegs 29 to allow the height of each corner of base 27 to be adjusted by the threading or unthreading of pegs 29 for the purpose of adjusting the height of support 23 and/or leveling the end cap installation apparatus 20. In some embodiments of the present invention, the end cap installation apparatus 20 is portable, moving from one work site to another work site. Portability may be achieved via the use of wheels 31 or the like on base 27, which may be, for example, fixed in stationary (for use) positions and mobile (for portability) positions via, for example, lock 33.

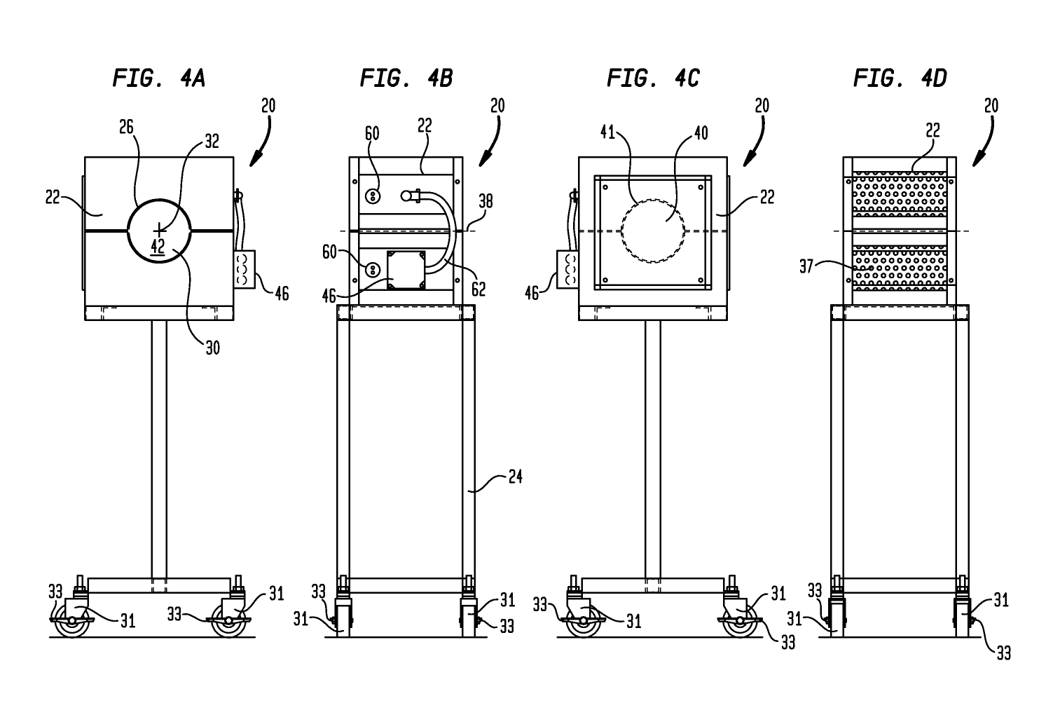

Inside the housing 22 is a heating chamber 26 with a substantially circular opening 30 at a first end and a removable cover 40 (FIG. 4C) at a second end. The heating chamber 26 has an approximately cylindrical wall 28 and, in one example embodiment, the chamber is substantially horizontal and is positioned in a substantially horizontally and vertically centralized location within the housing 22. In the depicted embodiment, wall 28 is made of a protective mesh that allows the heat from the heating elements 36 to pass therethrough into the heating chamber 26 while preventing direct contact between the combination of the end cap and cut end of electrical conductor and the heating elements 36, however, alternate walls may be substituted without departing from the scope hereof.

In some embodiments of the present invention such as the one shown in FIGS. 1, 4A-4D, and 5A-5C, the system further comprises one or more supports to assist the user in properly positioning the cut electrical conductor end 16E and the associated end cap 10 during the end cap installation process. The support(s) assist a user in steadily holding the cable end/end cap combination 18 in the proper position throughout the installation process. Supports may be internal, external, or both without departing from the scope of the present invention.

One exemplary internal support 70 is depicted in FIG. 1. This exemplary internal support 70 includes a semi-circular rest 74 held in position by a substantially horizontal vertical support 76 coupled at a first end to the approximate midpoint of semi-circular rest 74 and at a second end to housing 22. The semi-circular rest 74 is positioned in a U shape that allows the conductor end 16E and/or its associated end cap 10 to be rested thereupon during or after insertion into the heating chamber 26. Semi-circular rest 74 and support 76 are constructed of a high temperature alloy, however, alternate materials may be substituted without departing from the scope hereof.

Semi-circular rest 74 and support 76 are designed to hold the end cap 10 and its associated cut electrical conductor end 16E along the axis of the approximately cylindrical heating chamber 26. In one embodiment, the size of the internal support 74 is adjustable to allow it to accommodate the diameter of a variety of end caps having various sizes. In an alternate embodiment, multiple supports having various sizes are utilized and the appropriate support is installed prior to installation of the end cap 10.

In another example embodiment, the support(s) may be external to the end cap installation machine such as the exemplary external support 72 shown in FIG. 1. Exemplary external support 72 includes a semi-circular rest 82 held in position by substantially horizontal vertical support 80 and inverted L-shaped support 78. Support 80 is coupled at a first end to the approximate midpoint of semi-circular rest 82 and at a second end to support 78 via a locking mechanism 84 (e.g., a wing nut) passing through elongated apertures 81 and 83 in supports 80 and 78, respectively. Support 78 is coupled at a second end to stand 24.

Support 80 is held firmly to support 78 when locking mechanism is tightened thereby rendering the supports immovable. When locking mechanism 84 is loosened, the height of support 80 (and its attached support 82) relative to support 78 (and heating chamber 30) is adjustable. The user may adjust support 80 until the desired height is obtained, at which point the locking mechanism 84 is tightened to maintain support 80 (and its associated support 82) in the desired position.

The semi-circular rest 82 is positioned in a U shape that allows the conductor end 16E and/or its associated end cap 10 to be rested thereupon during or after insertion into the heating chamber 26. Semi-circular rest 82, support 78, and/or support 80 may be constructed of a high temperature alloy, however, alternate materials may be substituted without departing from the scope hereof. Semi-circular rest 82, support 78, and/or support 80 are designed to hold the end cap 10 and its associated cut electrical conductor end 16E along the axis of the approximately cylindrical heating chamber 26.

In the exemplary embodiment, semicircular rest has a diameter of approximately five inches (5″) to accommodate a variety of cable and end cap sizes and it is located approximately four (4″) inches from the heating chamber opening 30 so as not to interfere with the approximately four (4″) inches of free air space needed for cooling. In the depicted embodiment, this free air space is maintained around the entire heating chamber 26, however, alternate embodiments are envisioned that require less free air space or include other forms of cooling and/or ventilation. Alternate embodiments are envisioned in which the diameter of the rest and/or its distance from the heater chamber opening varies without departing from the scope hereof.

The external support(s) 72 could also include an integral insulated sleeve for user safety or an independent insulated sleeve may be utilized by the user prior to use of the system. Use of internal and/or external supports can act to eliminate or minimize hand fatigue that could result in non-optimal positioning of the conductor end and end cap combination.

In one embodiment, the size of the internal support rest 74 and/or 82 is adjustable to allow it to accommodate the diameter of a variety of end caps having various sizes. In an alternate embodiment, multiple supports having various sizes are utilized and the appropriate support is installed prior to installation of the end cap 10. However, alternate interior supports 70 and exterior supports 72, or combinations thereof, may be substituted without departing from the scope of the present invention.

Although rests 74 and 82 are shown herein as semicircular, alternate shapes may be substituted without departing from the scope hereof.

Referring now to FIGS. 2A through 2C, an example embodiment of the end cap 10 is shown. The end cap 10 has a substantially cylindrical body 15, an open end 12, a closed end 14, as well as a tapered section 19. In the depicted embodiment, the closed end 14 is substantially circular (FIG. 2b) but has a diameter smaller than the body of end cap 10. Tapered section 19 transitions the larger diameter body 15 of end cap 10 to the smaller diameter of the closed end 14 in a uniform manner. However, end caps having varying configurations may be substituted without departing from the scope hereof.

The end cap 10 of the system of the present disclosure is heat-shrinkable and constructed of a polymeric material that irreversibly shrinks when heated above a temperature characteristic of the material. The end cap 10 shown in FIGS. 2A through 2C is depicted in an initial, unshrunken shape. However, alternate materials may be substituted including, without limitation, rubber and polyethelene. In one example embodiment, the end cap 10 has a heat-activated adhesive applied to the interior walls 13 thereof, but an adhesive is not required to implement the present invention.

FIGS. 3A through 3C depict how the end cap 10 protects a cut electrical conductor end 16. The end cap 10 is provided for sliding over the end 16E of a cut electrical conductor 16 such as the one shown in FIG. 3A. Prior to installation of the end cap 10 via an end cap installation apparatus, end cap 10 loosely surrounds the outer surface of the end 16E of an electrical conductor 16 as shown in FIG. 3B. In this state, a combination of the end cap 10 and the cut electrical conductor end 16E enclosed therein is inserted into an end cap installation apparatus such as the end cap installation apparatus 20 shown in FIG. 1. FIG. 3C shows the end of the electrical conductor with its installed end cap 18, the end cap 10 irreversibly shrunken onto the electrical conductor, sealing and protecting the cut electrical conductor end 16.

FIGS. 4A through 4D show one example embodiment of the end cap installation apparatus 20 in greater detail. FIG. 4A and FIG. 4C depict the right and left sides, respectively, of the housing. In the depicted embodiment, the chamber 26 is substantially cylindrical and passes completely though the housing 22 with openings 30 and 41 at either end of chamber 26. However, alternate embodiments are envisioned in which the chamber 26 does not extend completely through housing 22 without departing from the scope hereof. Also, chamber 26 sits in a horizontal position within the housing 22. The circular opening 30 is configured for receiving the end cap 10 in combination with the cut electrical conductor end 16 into the end cap installation machine, the combination of the end cap 10 and cut electrical conductor end 16 inserting into the circular opening 30 in a substantially centered position.

Removable cover 40 is positioned to removably cover opening 41. Through the opening 30, an inwardly facing surface 42 of removable cover 40 opposite the opening 30 is visible. The cover 40 has a center 32. The inwardly facing surface 42 is configured for maintaining the combination of the end cap 10 and cut electrical conductor end 16 in the substantially centered position within the chamber 26 and/or for applying pressure on the combination during shrinking of the end cap 10. In the depicted embodiment, the opening 30 is shown on the right side and the cover 40 is shown on the left side, but this is arbitrary and the apparatus can have the opening on the right or left side, or front or back sides, and a corresponding cover on the left or right side, or back or front side, respectively without departing from the scope of the present invention. Also, embodiments of the present invention are envisioned in which the cover is omitted.

FIG. 4B shows the rear of the housing 22. On the rear is an electrical terminal box 46, a plurality of temperature sensing device ports 60 and wiring 62 connecting the terminal box 46 to the chamber within housing 22. At the rear of the housing 22, in one example embodiment is a hinge 38, the housing opening to allow, for example, the chamber to cool or to be cleaned.

FIG. 4D depicts the front of the housing 22, a plurality of grills 37 configured within the front wall to provide ventilation for the heating chamber 26.

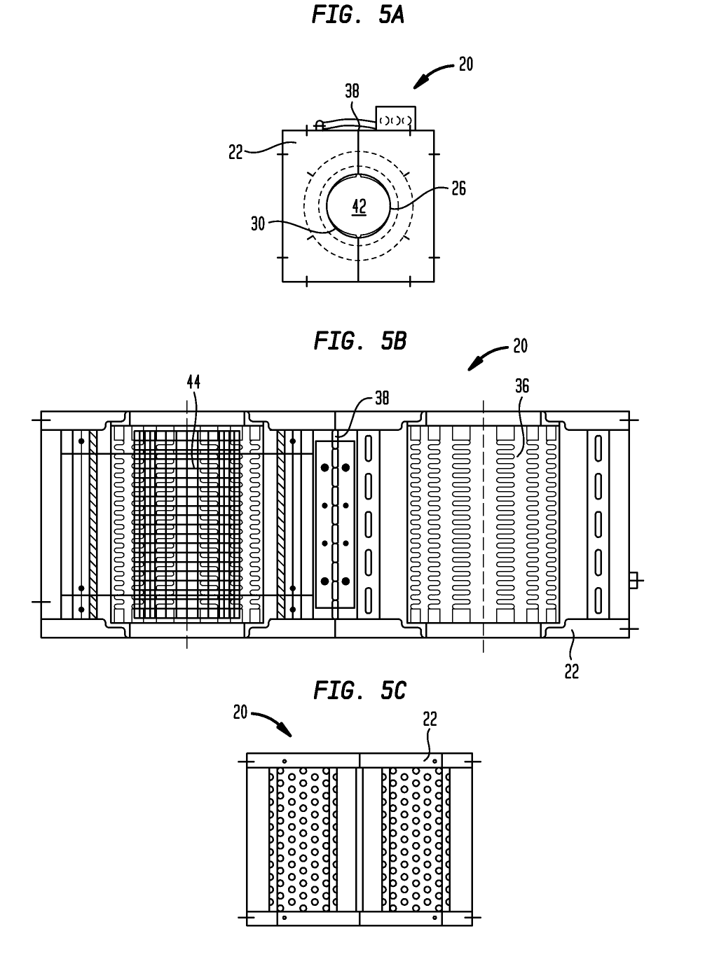

FIGS. 5A through 5C show the apparatus of the system in greater detail. In FIGS. 5A-5C, the housing 22 of the apparatus is shown rotated 90 degrees relative to the depiction of the housing 22 in FIGS. 4A-4D. In FIG. 5A, the hinge 38 is shown and the chamber 26 is bisected. The inwardly facing surface 42 of the cover 40 (FIG. 4C) is visible through the opening 30. FIG. 5B depicts the chamber 26 selectively open at the hinge 38. The heating elements 36 are covered with a protective mesh covering 44, shown on a first portion of the housing 22. The heating elements 36 on the second portion are shown without the protective mesh covering for illustrative purposes. It is understood that the apparatus can have none, one or both sides of the chamber 26 covered by the protective mesh covering 44 within the inventive concept. FIG. 5C depicts the heating elements 36 of the apparatus 20 in the housing 22, without a front covering. FIGS. 5A through 5C depict an exemplary heating chamber, however, alternate heating chambers may be substituted without departing from the scope hereof, including chambers without a hinge, chambers with varying wiring, chambers having alternate sizes and shapes (e.g., rectangular heating chambers), and chambers having non-circular cross sections (e.g., square and octagonal cross-sections).

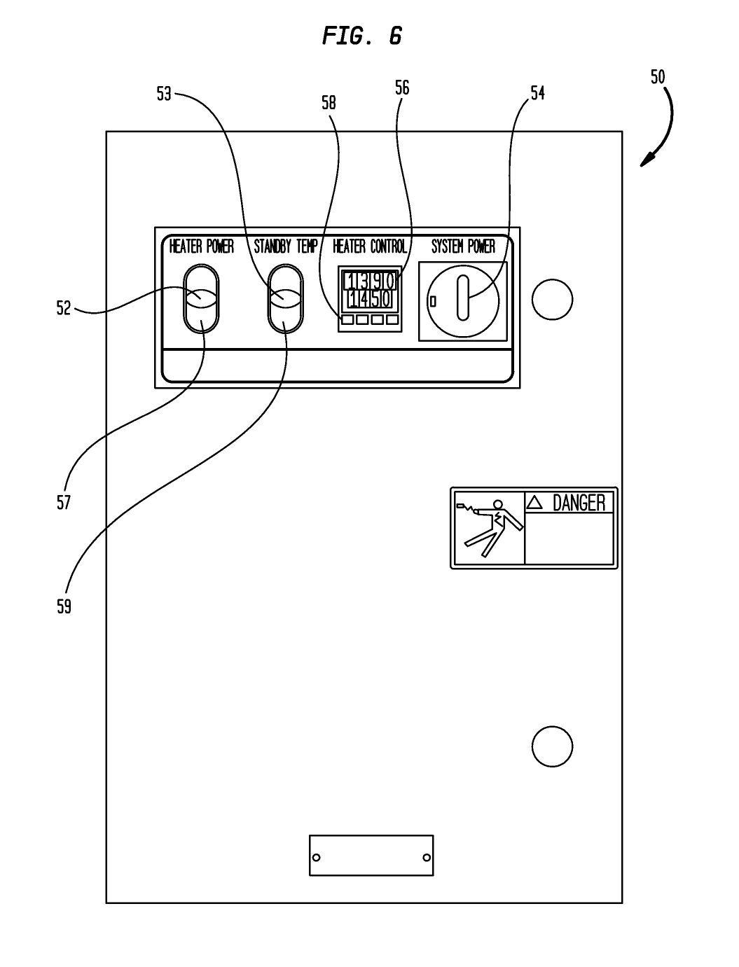

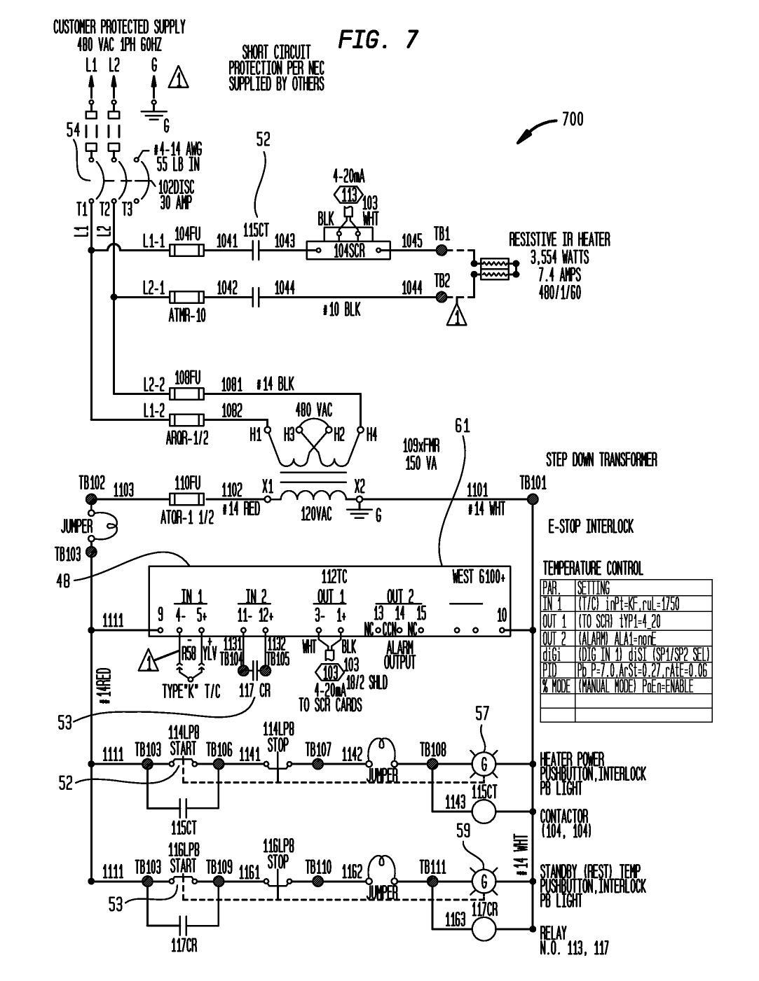

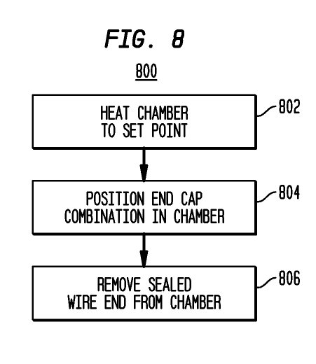

FIG. 6 shows an example embodiment of a control panel 50 for controlling the end cap installation apparatus 20. The control panel 50 is wired with circuitry such as circuit 700 as depicted in FIG. 7. As best seen in FIG. 7, circuit 700 operationally connects at least one temperature sensing device 48 located within or proximal to the heating chamber 26 to the heating elements 36 for control thereof. In the depicted embodiment, temperature sensing device 48 is a thermocouple but alternate devices may be substituted without departing from the scope of the present invention including, without limitation, a thermistor and a resistance temperature detector (“RTD”).

In the depicted exemplary embodiment, the apparatus has one primary temperature sensing device 48 and one backup temperature sensing device. The at least one temperature sensing device 48 is operationally connected to circuit 700 through a shielded temperature sensing device extension connecting to a port 60 shown in FIG. 4B on the back of the housing 22, and into the appropriate temperature controller location inside the control panel 50. Similarly, the heating element is also connected to the appropriate temperature controller location inside the control panel 50. The temperature controller 61 reads the temperature sensed by the temperature sensing device 48 and facilitates automatic set point closed loop control of the temperature of the heating chamber 26 of the end cap installation apparatus 20. In the depicted embodiment of the present invention, temperature controller 61 is a P6100 controller as manufactured by West Temperature Control Solutions, however, alternate controllers may be substituted without departing from the scope of the present invention. The control panel 50 may be integrated as part of the end cap installation apparatus stand 24, or it may be mounted to a wall or other surface near the end cap installation apparatus 20. In the latter embodiment, the temperature sensing device extension (REF. NO. ?) extends from the control panel 50 and is plugged into a temperature sensing device jack/port 60 on the rear/back of the heating chamber 26 as shown in FIG. 4B, electrically coupling to the control panel 50.

As seen on the face of the control panel of FIG. 6, the exemplary control panel 50 has a plurality of switches including a power switch 54, an activation switch 52, and a standby switch 53. Such switches may be any type of switch capable of indicating on or off positions to a control circuit such as for example circuit 700 as depicted in FIG. 7. In the exemplary embodiment depicted in FIGS. 6 and 7, circuit 700 also includes a temperature controller 61 that includes an integral temperature display 56 and temperature adjustment 58. In the depicted embodiment, temperature controller 61 is mounted inside the door of the control panel 50, the latter of which may be attached directly to the housing of the apparatus 20 or in a nearby location.

The control panel 50 controls the heating of the end cap 10 when it is in the chamber 26. Unlike torches and heat guns, where the user does not know what temperature is being produced to shrink the end cap, the apparatus of the system provides a uniformly heated environment at a known temperature within the chamber 26. The entire end cap 10 is simultaneously exposed to the known, uniform temperature to allow the end cap 10 to be uniformly shrunk such that gaps in the end cap 10 are avoided and the cut electrical conductor end 16 is completely encased in the shrunken end cap 10. In this manner, the system provides a predictable shrinking and consistent, easily repeatable results.

The following are example embodiments of specifications for the apparatus of the system. It is understood that these specifications are provided as illustrations and are not limitations of the system disclosed herein.

Heater Specifications

| Model No. | Example-S | | | | | | Example-T4S | |
|---|---|---|---|---|---|---|---|---|
| Voltage | 208 | V | 220 | V | 240 | V | 480 | V |
| Full Load | 12.8 | A | 13.6 | A | 14.8 | A | 7.4 | A |
| Amperage | | | | | | | | |
| Wattage at | 1210 | W | 1355 | W | 1613 | W | 1613 | W |
| Standby | | | | | | | | |
| Temperature | | | | | | | | |
| Wattage at | 2666 | W | 2985 | W | 3554 | W | 3554 | W |
| Installation | | | | | | | | |
| Temperature | | | | | | | | |

It should be noted that the control panel circuitry can be interlocked with other start/stop contacts to turn on or off the heating elements 36, for example, to implement an emergency stop circuit or for automatic operation of the standby and/or operating modes.

The following are exemplary detailed operating instructions for using the control panel 50 and its associated circuit 700 to further illustrate the concepts and not limitations:

Setting the Control Circuit Parameters

Before installation of the end caps 10 on a cut electrical conductor end 16 and prior to activating the standby or installation circuits, the temperature control set points may be set by the user via, for example, temperature adjustment 58. In the depicted embodiment of the present invention, the end cap installation apparatus 20 uses a proportional-integrative-derivative (“PID”) system to optimize the heating process. Exemplary settings for the P, I, and D settings are 7.0, 0.27, and 0.06, respectively. The user may adjust these settings as necessary to obtain optimum performance and alternate settings may be substituted without departing from the scope hereof.

Additionally, the user sets the operating temperature set point (“SP1”) to the recommended installation temperature for the size and/or type of end cap being installed. In one embodiment, this set point value ranges from 1200 Deg F to 1450 Deg F, however, alternate temperatures and ranges may be substituted without departing from the scope hereof.

The standby temperature set point (“SP2”) is also set by the user. This is the temperature at which the heating chamber 26 will be maintained when the end cap installation process is not being performed. This idle temperature acts to keep the heating chamber warm, save energy, and extend the heater life. Also, a warm heating chamber will reach a stable operating temperature much faster as compared to initiating an end cap installation with a cold heating chamber. A standby temperature setpoint of 400 Deg F is recommended, but alternate operating and standby temperature setpoints may be substituted without departing from the scope hereof.

To change the temperature setpoints, the user utilizes the temperature adjustment 58 which may include switches or the like and is located on the face of the control panel 50 under the temperature display 56, as shown in FIG. 6. The up and down arrows allow the user to select the desired SP1 and SP2 temperature setpoints.

Start-Up Sequence

Verify the end cap installation apparatus 20 is clear of people, objects, etc. and notify all users that the end cap installation apparatus 20 is being energized.

Turn on the system power switch via activation of power switch 54. This switch provides power to the control panel 50 and its associated circuitry and end cap installation apparatus 20.

Set the operating temperature set point (SP1) and the standby temperature set point (SP2) via entry of same via temperature adjustment 58. Exemplary set point values are discussed in greater detail below.

Activate the standby temperature control circuit 700 via activation of standby switch 53. This switch provides power to the control panel 50 and its associated circuitry and end cap installation apparatus 20. In the depicted embodiment, activation of the standby temperature control circuit 700 via standby switch 53 energizes the standby lamp 59 to indicate activation of standby mode to the user.

Using the End Cap Installation Apparatus

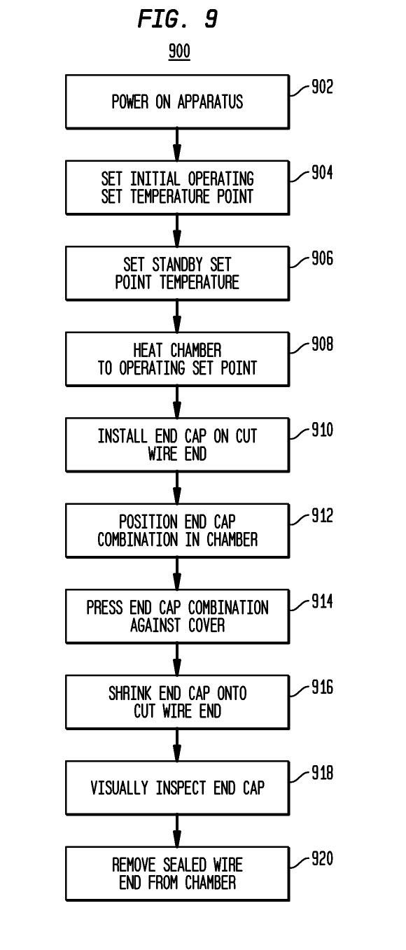

Referring now to FIG. 9, depicted is one exemplary process 900 for installing an end cap in accordance with the present invention. First, at 902, the end cap installation apparatus 20 and its associated control circuitry are powered on as described in greater detail herein. Then, at 904 and 906, the operating and standby temperature setpoints, respectively, are set by the user, for example, as described above.

Next, at 908, the temperature of a heating chamber of an end cap installation apparatus is heated to an operating temperature set point. A table of exemplary operating temperature set points is provided herein for the sake of illustration, however, alternate temperatures may be substituted without departing from the scope of the present invention as needed, for example, to accommodate end cap materials and cut electrical conductor ends. Step 908 may be activated, for example, via pressing an activation switch such as activation switch 52 which indexes a temperature controller to energize the heating elements in the end cap installation apparatus 20 as needed to raise the temperature in the heating chamber 26 to the operating temperature setpoint. In the depicted embodiment, activation of the operating temperature control circuit via operating switch 52 energizes the operating lamp 57 to indicate activation of operational mode to the user. When the operating setpoint has been reached, this may be indicated to a user, for example, via an operating temperature lamp, display of the actual heating chamber temperature, or the like displayed, for example, on a face of a control panel associated with the end cap installation machine.

Once the temperature has reached the operating temperature setpoint, steps 910 and 912 are performed. At 910, the end cap 10 is slid onto the end of the cut electrical conductor 16 and thereafter at step 912 the combination end cap and end of the cut electrical conductor is positioned in the end cap installation apparatus 20. In some embodiments, the end cap 10 is provided to the user with an adhesive on at least a portion of its inwardly facing surfaces, and/or an adhesive is applied by the user to the inwardly facing surfaces of the end cap 10 as a part of step 910. Also, it should be noted that step 910 may be performed by a user while the user waits for completion of step 908, or at some other point in the process prior to 910. In the depicted embodiment, the user positions the end cap 10 in combination with the cut electrical conductor end 16 in the heated chamber 26 in a substantially centered position by passing same through a substantially circular opening of the housing 22. In some embodiments of the present invention, this positioning is facilitated via the use of an internal support 70, an external support 72, or the combination of the two.

Next, at 914, the end cap 10 may be optionally pressed firmly against the approximate center of the interior facing surface of a removable cover of the heating chamber 26. This pressing action acts to maintain the combination of the end cap 10 and cut electrical conductor end 16 in the substantially centered position and/or to apply pressure to the combination further securing the cut end within the end cap 10. For example, this may be preferred for certain end caps having a nominal diameter of two and one half inches (2.5″) and greater. When utilized, this step minimizes the potential for forming errors.

At step 916, the end cap 10 is shrunk onto the cut electrical conductor end 16. The recommended installation time chart provided herein may be used as a guide for the approximate expected installation time, but the user may also use his or her best judgment on when the end cap 10 has sufficiently shrunk to the cut electrical conductor end 16.

For example, at optional step 918, the end cap 10 and its associated cut electrical conductor end 16 should be removed from the end cap installation apparatus 20, or the heating chamber 26 thereof, after the user visually determines that the adhesive (if applicable) is beginning to emerge from the entire perimeter of the end cap 10. For example, the user may visually inspect the end cap 10 through the opening of the chamber 26.

When the end cap 10 has been completely installed on the cut electrical conductor end 16, the cut electrical conductor end 16 and its associated end cap 10 are removed from the end cap installation apparatus at 920. Thereafter, the user should allow the cut electrical conductor end 16 and end cap 10 to cool before touching. Upon completion of the installation process, the user may choose to turn off the end cap installation apparatus 20 via activation or deactivation of a power switch or the like. Or, the user may press “Standby” to keep the machine running at a standby temperature to reduce subsequent heat-up times.

The combination of the end cap 10 and the cut electrical conductor end 16 is removed from the chamber after the end cap 10 shrinks and adheres to the cut electrical conductor end 16, thereby protecting the cut electrical conductor end.

In one embodiment of the method, if the apparatus is not immediately needed, the chamber 26 is switched to the standby set point temperature. If the apparatus 20 is not needed for longer periods, the apparatus 20 is powered off. If a different operating set point temperature is required, the operating set point temperature is reset through the control panel 50.

Estimated Installation Time Chart

| | Cable | Ideal Installation | Recommended Range of |
|---|---|---|---|
| | Diameter | Temperature | Installation Time |
| End Seal | Range (in) | (° F.) | (seconds) |
| 0 | 0.16-0.31 | 1450 | 9-11 |
| 1 | 0.31-0.63 | 1450 | 11-17 |
| 2 | 0.47-1.02 | 1450 | 9-15 |
| 3 | 0.8-1.37 | 1450 | 9-27 |
| 8 | 1.2-1.85 | 1450 | 14-24 |
| 4 | 1.6-2.67 | 1450 | 11-18 |
| 7 | 1.8-2.67 | 1200 | 24-48 |
| 6 | 2.9-4.5 | 1200 | 28-53 |

A method of protecting an end of a cut electrical conductor by sealing the end is disclosed with reference to the system described hereinabove.

FIG. 8 is a flowchart of an exemplary method 800 of protecting a cut electrical conductor end in accordance with one embodiment of the present disclosure. Process 800 starts at 802, at which the temperature of a heating chamber of an end cap installation apparatus is heated to an operating temperature set point. A table of exemplary operating temperature set points is provided hereinbelow for the sake of illustration, however, alternate temperatures may be substituted without departing from the scope of the present invention as needed, for example, to accommodate end cap materials and cut electrical conductor ends. Step 802 may be activated, for example, via pressing an activation switch such as activation switch 52 which indexes a temperature controller to energize the heating elements in the end cap installation apparatus as needed to raise the temperature in the heating chamber to the operating temperature setpoint. When the setpoint has been reached, this may be indicated to a user, for example, via an operating temperature lamp, display of the actual heating chamber temperature, or the like displayed, for example, on a face of a control panel associated with the end cap installation machine.

Next, at 804, when the temperature of the heating chamber has reached the operating temperature set point and this has been indicated to a user, the user positions the end cap in combination with the cut electrical conductor end in the heated chamber in a substantially centered position by passing same through a substantially circular opening of the housing. In some embodiments of the present invention, this positioning is facilitated via the use of an internal support 70, an external support 72, or the combination of the two.

Then, at 806, when the user has visually seen that the end cap has sufficiently shrunk, or a sufficient amount of time has passed for such shrinking to occur, the cut electrical conductor end encased within the shrunken end cap which uniformly adhered thereto in step 804 is removed from the chamber. In this manner, the end of the cut electrical conductor is protected from the environment and the integrity of the electrical conductor and its associated spool of electrical conductor are kept intact. In some embodiments, the control panel includes a timer to indicate the end of step 804, however, a timer is not required to implement the present invention.

Although FIG. 7 depicts a control board including hardware, it may be appreciated by one of skill in the art that the same processes, functions, etc. may be performed via software or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A system for protecting an end of a cut electrical conductor by sealing the end, comprising:
a heat-shrinkable end cap configured for sealing an end of a cut electrical conductor; and
an end cap installation apparatus having a:
housing;
a heating chamber;
a control panel; and
a temperature sensing device coupling to the heating chamber and operationally connecting to the control panel.

2. The system according to claim 1, wherein the heating chamber has an approximately cylindrical interior wall having a plurality of heating elements configured for heating the heating chamber.

3. The system according to claim 2, wherein the heating chamber is in a horizontal position within the housing.

4. The system according to claim 1, wherein the heating chamber has a substantially circular opening configured for accommodating the end cap in combination with the cut electrical conductor end, the combination of the end cap and the cut electrical conductor end inserting into the circular opening in a substantially centered position.

5. The system according to claim 4, wherein the heating chamber has a removable cover opposite the substantially circular opening, the removable cover having an inwardly facing surface configured for maintaining the combination of the end cap and the cut electrical conductor end in the substantially centered position.

6. The system according to claim 2, wherein the heating elements are operationally connecting to the control panel.

7. The system according to claim 6, wherein the temperature sensing device has a shielded extension connecting through a port in the housing of said apparatus and operationally connecting to the control panel.

8. The system according to claim 7, wherein the heating elements are controlled by a proportional integrative derivative (PID) system.

9. The system according to claim 8, further comprising a support system for maintaining the combination of the end cap and the cut electrical conductor end in the substantially centered position.

10. A system according to claim 1 further comprising a stand.

11. A system according to claim 1 further comprising at least one of the group consisting of an interior support, an exterior support, and combinations thereof.

12. A system according to claim 11, wherein the height of the exterior support is adjustable.

13. A system according to claim 11, wherein at least one of the group consisting of an interior support, an exterior support, and combinations thereof includes a semicircular rest.

14. A system according to claim 1, further comprising:
at least one wheel, the wheel having a mobile position and a stationary position.

15. A system according to claim 14, further comprising:
at least one lock, the lock setting the at least one wheel to the mobile position or the stationary position.

16. A method for protecting an end of a cut electrical conductor by sealing the end, comprising the steps of:
setting a temperature setpoint in a heating chamber in an end cap installation apparatus to an operating temperature set point;
positioning an end cap in combination with an end of a cut electrical conductor into the heating chamber in a substantially centered position through a substantially circular opening located at a first end of the heating chamber, the heating chamber rapidly shrinking the end cap onto the cut electrical conductor end; and
removing the combination of the end cap and the end of the cut electrical conductor from the heating chamber after the end cap shrinks and adheres to the end of the cut electrical conductor, thereby protecting the end of the cut electrical conductor.

17. The method according to claim 16 further comprising the step of:
pressing the end cap against an inwardly facing surface of a removable cover, the removable cover located at a second end of the heating chamber, the second end on the opposite end of the heating chamber from the circular opening, the inwardly facing surface of the removable cover operative for maintaining the combination of the end cap and the end of the cut electrical conductor in the substantially centered position.

18. The method according to claim 16 further comprising the step of:
sliding the end cap over the end of the cut electrical conductor to create the combination of the end cap and the end of the cut electrical conductor, the end cap substantially surrounding the end of the cut electrical conductor.

19. The method according to claim 16 further comprising the step of:
setting the operating temperature set point through a control panel of the end cap installation apparatus.

20. The method according to claim 16 further comprising the step of:
setting the temperature setpoint of the heating chamber to a standby temperature set point after the end cap shrinks and adheres to the end of the cut electrical conductor.

21. The method according to claim 20, wherein the step of setting the temperature of the chamber to a standby temperature set point is performed via a control panel.

22. The method according to claim 16 further comprising the step of:
visually inspecting the combination in the heating chamber; and
determining that the end cap is completely shrunk and adhered to the end of the cut electrical conductor before removing the combination from the heating chamber.

23. The method according to claim 16, wherein the end cap shrinks in a uniform manner.

24. The method according to claim 16 therein the positioning of the end cap in combination with the end of a cut electrical conductor is performed utilizing at least one of the group consisting of an interior support, an exterior support, and combinations thereof.
